(19) United States
(12) Patent Application Publication
(10) Pub. No.: US 2021/0250250 A1
(43) Pub. Date: Aug. 12, 2021

(54) DEPLOYMENT OF AN APPLICATION IN A DISTRIBUTED COMPUTING ENVIRONMENT

(71) Applicant: HEWLETT PACKARD ENTERPRISE DEVELOPMENT LP, Houston, TX (US)

(72) Inventor: Alex Reznik, Pennington, NJ (US)

(21) Appl. No.: 16/785,893

(22) Filed: Feb. 10, 2020

(51) Int. Cl. H04L 12/24; H04L 29/08

(52) U.S. Cl. CPC H04L 41/5009; H04L 67/10; H04L 41/0896; H04L 41/5019

(57) ABSTRACT

Examples described herein deploy an application in a distributed computing environment to comply with core requirements of an SLA. Examples include identifying, by a processing resource, a plurality of components of the application, a plurality of requirements of the application according to a service level agreement (SLA), and a plurality of sites of the distributed computing environment, and determining, by the processing resource, a plurality of mappings of the components to the sites, wherein for each mapping, each component is mapped to a single site capable of satisfying at least one of the requirements. Examples include assigning, by the processing resource for each mapping, a tier among a plurality of tiers of the SLA that corresponds to a most stringent requirement among the requirements that must be satisfied by the sites according to that mapping, and selecting, by the processing resource among the mappings, a first mapping that is assigned to the tier among the assigned tiers having a highest availability for the most stringent requirement. Examples include deploying at least one of the components to the sites according to the first mapping.

### BACKGROUND

Multi-access edge computing (MEC) provides cloud-computing capabilities at the edge of a network. As used herein, an “edge” of a network refers to one or more locations of the network where data is generated, or proximate to where data is generated, in relation to a centralized cloud or data center. MEC allows data to be analyzed, processed, and/or stored at or near the edge of a network rather than at a centralized cloud or data center, and may thereby reduce latency and improve real-time performance of the network.

Applications which are deployed in a computing environment may be subject to service level agreements between a service provider (e.g., Internet service provider, mobile service provider, etc.) and a client (e.g., content provider, application provider, etc.) As used herein, a service level agreement (SLA) refers to an agreement between a service provider and a client regarding certain aspects of the service, such as compute and storage capacity, latency capacity, throughput capacity, availability of service, etc., that the service provider is to provide to the client.

### BRIEF DESCRIPTION OF THE DRAWINGS

Various features and advantages of the invention will become apparent from the following description of examples of the invention, given by way of example only, which is made with reference to the accompanying drawings, of which:

FIG. 1 is a block diagram of an example MEC orchestrator 100 for deploying an application in a distributed computing environment.

FIG. 2 is a block diagram of an example distributed computing environment 200 including an MEC orchestrator for deploying an application.

FIGS. 3A to 3C are block diagrams which show an example deployment of an application in a distributed computing environment.

FIGS. 4A to 4C show an example functionality 400 to deploy an application in a distributed computing environment.

FIG. 5 is a block diagram of an example computer system 500 in which various embodiments described herein may be implemented for deploying an application in a distributed computing environment.

### DETAILED DESCRIPTION

Despite the great potential that MEC offers for reducing latency and providing real-time performance in networks, existing MEC technologies may not ensure that an application deployed in a distributed computing environment complies with core requirements of an SLA. As used herein, a distributed computing environment refers to a computing environment (e.g., an MEC system) which comprises a plurality of unique computing sites. As used herein, a core requirement of an SLA refers to one or more overall requirements (i.e., end-to-end requirements) of the application that must be satisfied under the SLA. Existing MEC technologies may not ensure that an application is deployed in a distributed computing environment to comply with core requirements of an SLA, when the application comprises multiple components which each have different requirements and are deployed at different sites of the distributed computing environment. Moreover, existing MEC technologies may not ensure that components of an application are deployed in a distributed computing environment to comply with core requirements of an SLA, when other applications subject to different SLAs are also deployed in the distributed computing environment.

As an example, suppose that an SLA between a service provider and a client provides that the service provider will deploy application X having two components, X₁ and X₂. In addition, the SLA provides that the service provider will deploy application X to satisfy a core performance requirement P_{xc} and a corresponding availability requirement R_{XC} of ≥85% (i.e., the SLA will deploy application X to satisfy the core performance requirement P_{XC} with at least 85% availability). Moreover, the SLA provides that the service provider will deploy component X₁ to satisfy a performance requirement P_{X1} and a corresponding availability requirement R_{X1} of ≥75%, and that the service provider will deploy component X₂ to satisfy a performance requirement P_{X2} and a corresponding availability requirement R_{X2} of ≥95%. Furthermore, the SLA provides that the core performance requirement P_{XC} for application X is the sum of performance requirement P^{X1} for component X₁ and performance requirement P_{X2} for component X₂, i.e., P_{XC}=P_{X1}+P_{X2}.

In such example, the service provider may decide to deploy application X in a distributed computing environment which comprises two sites, S₁ and S₂. Each site is located at the edge of the distributed computing environment and has compute and storage resources which are connected to a unique L₂ network. In addition, neither of the sites S₁ and S₂ has sufficient compute and storage resources to deploy both components X₁ and X₂, but each site has sufficient compute and storage resources to deploy one of components X₁ and X₂. In such example, the service provider may decide to deploy component X₁ at site S₁ and component X₂ at site S₂. For such deployment, suppose that the deployed component X₁ at site S₁ satisfies performance requirement P_{X1} with an availability of at least 80%, and that the deployed component X₂ at site S₂ satisfies performance requirement P_{X2} with an availability of at least 99.9%. Although such deployment satisfies the availability requirements R_{X1} and R_{X2} corresponding to application components X₁ and X₂, this deployment would nevertheless fail to satisfy the core availability requirement R_{XC} of ≥85% of application X. This is because the overall availability of core performance requirement P_{XC} can be no greater than at least 80%, i.e., the availability of performance requirement P_{X1} of deployed component X₁. Moreover, since the deployed components X₁ and X₂ are at different sites S₁ and S₂, which each have unique compute and storage resources and are connected to a unique L2 network, existing MEC technologies may not ensure that the deployment of application X at the two sites S₁ and S₂ will satisfy the core availability requirement R_{XC}. Thus, existing MEC technologies may not ensure that an application is deployed to satisfy core requirements of an SLA when the application has multiple components which are deployed to different sites in a distributed computing environment.

To address these issues, examples described herein may deploy an application in a distributed computing environment to comply with core requirements of an SLA. Examples described herein may identify, by a processing resource, a plurality of components of the application, a plurality of requirements of the application according to an SLA, and a plurality of sites of the distributed computing environment, determine, by the processing resource, a plurality of mappings of the components to the sites, wherein for each mapping, each component is mapped to a single site capable of satisfying at least one of the requirements. Examples described herein may assign, by the processing resource for each mapping, a tier among a plurality of tiers of the SLA that corresponds to a most stringent requirement among the requirements that must be satisfied by the sites according to that mapping, and select, by the processing resource among the mappings, a first mapping that is assigned to the tier among the assigned tiers having a highest availability for the most stringent requirement. Examples described herein may deploy at least one of the components to the sites according to the first mapping.

In this manner, examples described herein may ensure that an application is deployed in a distributed computing environment to comply with core requirements of an SLA. For example, in such examples, the processing resource may assign, for each mapping, a tier among a plurality of tiers of the SLA that corresponds to a most stringent requirement among the requirements that must be satisfied by the sites according to that mapping, and select, by the processing resource among the mappings, a first mapping that is assigned to the tier among the assigned tiers having a highest availability for the most stringent requirement, thereby ensuring that the selected mapping of the components to the plurality of sites may satisfy the core requirements of the SLA. Moreover, examples described herein may deploy at least one of the components to the sites according to the first mapping, thereby ensuring that each of the deployed components will satisfy the core requirements of the SLA.

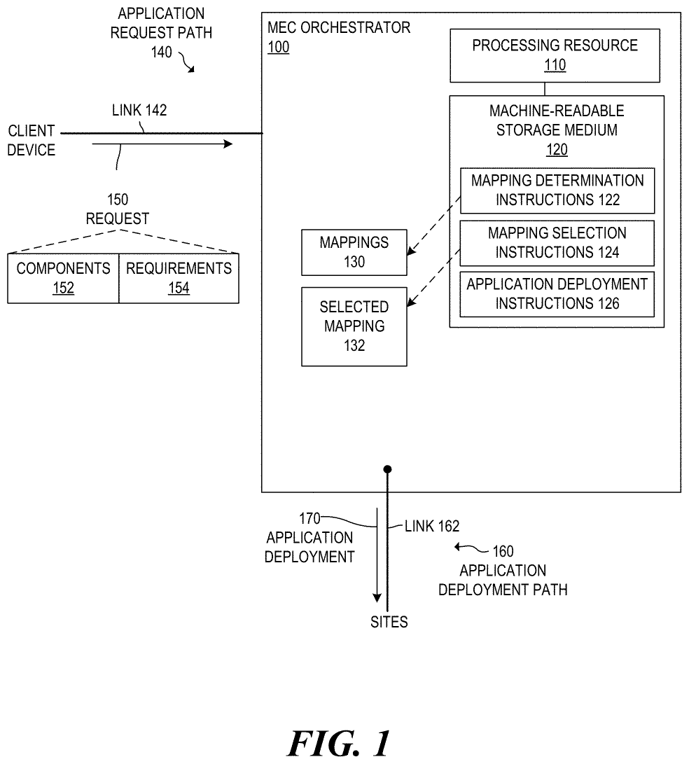

Referring now to the drawings, FIG. 1 is a block diagram of an example MEC orchestrator 100 for deploying an application in a distributed computing environment. In the example of FIG. 1, MEC orchestrator 100 includes at least one processing resource 110 and at least one machine-readable storage medium 120 comprising (e.g., encoded with) at least mapping determination instructions 122, mapping selection instructions 124, and application deployment instructions 126 that are executable by at least one processing resource 110 of MEC orchestrator 100 to implement functionalities described herein in relation to mapping determination instructions 122, mapping selection instructions 124, and application deployment instructions 126, respectively.

In the example of FIG. 1, MEC orchestrator 100 may provide MEC system level management for a MEC system. MEC orchestrator 100 may maintain an overall view of the MEC system based on deployed MEC hosts (at one or more sites), available resources (e.g., compute and storage resources at one or more sites), available MEC services, and a topology of the MEC system. In addition, MEC orchestrator 100 may perform on-boarding (e.g., deployment) of application packages (e.g., applications, components of applications, etc.), check the integrity and authenticity of application packages, validate application rules and requirements and adjust such rules and requirements (as necessary) to comply with client policies (e.g., SLA requirements), keep a record of on-boarding packages, prepare a virtualization infrastructure manager to handle the applications, or a combination thereof. Optionally, MEC orchestrator 100 may comprise an operations support system (OSS) (not shown), wherein the OSS may receive requests via a customer facing services (CFS) portal and/or from device applications for instantiation (i.e., deployment) and termination of applications (i.e., MEC applications) and/or components of such applications. In addition, MEC orchestrator 100 may determine whether to grant such requests. Optionally, MEC orchestrator 100 may comprise a network function virtualization orchestrator (NFVO) (not shown) which may manage a lifecycle of one or more network services, including deployments of applications, by treating each application instance as a virtual network function (VNF) instance. Moreover, MEC orchestrator 100 may delegate the management of one or more applications to the NFVO which manages such applications as part of one or more NFV network services. In addition, MEC orchestrator 100 may delegate the management of the application VNF packages to the NFVO.

In the example of FIG. 1, mapping determination instructions 122 may be configured to receive a request 150 via an application request path 140 to deploy an application according to a plurality of requirements of an SLA. Application request path 140 may include any suitable communication link 142 (e.g., wired or wireless, direct or indirect, etc.) between MEC orchestrator 100 and a client device. Request 150 may include components information 152 which identifies components of the application to be deployed according to the SLA, and requirements information 154 which identifies a plurality of core requirements of the application according to the SLA.

In examples described herein, an application request path may be a combination of hardware (e.g., communications interfaces, communication links, etc.) and instructions (e.g., executable by a processing resource) to communicate (e.g., receive, output, etc.) application requests from a third-party (e.g., from a client via a client device) in a computing environment.

In examples described herein, a client device may comprise one or more computing devices which are associated with one or more clients (e.g., ISP, mobile service provider, etc.) and which may communicate with MEC orchestrator 100. For instance, the client device may communicate with MEC orchestrator via application request path 140.

In examples described herein, a component of an application may refer to a portion of the application which is to be deployed to a single site in a distributed computing environment. Moreover, each site of the distributed computing environment may comprise compute and storage resources which are connected to a unique Layer 2 (L2) network. For example, each site of the computing environment may comprise unique compute and storage resources which are connected to a unique local area network (LAN) or a virtual local area network (VLAN). Furthermore, each site of the distributed computing environment may be located at a unique location at an edge of the distributed computing environment. In addition, in examples described herein, each site may comprise an MEC host which contains a MEC platform and virtualization infrastructure which provides compute, storage, and/or network resources for running applications and/or components of applications. In such examples, each application and/or component may be instantiated (i.e., deployed) on the virtualization infrastructure of the MEC host based on (e.g., in response to) requests which are validated by the MEC system.

In examples described herein, requirements of an SLA may comprise compute and storage requirements. For example, the requirements of the SLA may comprise compute and storage requirements of each component of the application which must be satisfied by compute and storage resources at a single site of a distributed computing environment.

In examples described herein, requirements of an SLA may comprise link requirements. Moreover, the requirements of the SLA may comprise link latency requirements. For example, the requirements of the SLA may comprise link latency requirement between the components of the application which must be satisfied by a communication link between sites of a distributed computing environment. Optionally, the requirements of the SLA may comprise link throughput requirements between the components of the application, which must be satisfied by a communication link between the sites of a distributed computing environment.

In examples described herein, requirements of an SLA may comprise one or more of optional requirements. In such examples, each of the one or more optional requirements may comprise acceptable ranges of requirements for one or more components, and/or requirements between two or more components, according to the SLA. In examples described herein, optional requirements may comprise one or more of the following requirements: signaling, control, and management plane requirements, such as latency requirements and message delivery rate requirements; data transfer plane requirements, such as User Datagram Protocol (UDP) endpoint throughput and availability requirements, and transmission control protocol (TCP) endpoint availability, reset (RST) rate, and duplicate acknowledgement (DupACK) rate requirements; domain name system (DNS) performance requirements, such as look up latency, server error rate, and effective pass rate requirements; database requirements, such as availability, read time, write time, and standardized query response time requirements; information services requirements, such as response time, information accuracy, and availability requirements; action services requirements such as request success rate, request success latency, and availability requirements; and monitoring/logging services requirements, such as information availability, information accuracy, information precision, information correctness, and information retention time requirements.

In the example of FIG. 1, mapping determination instructions 122 may be configured to, in response to the request, identify a plurality of components of the application and a plurality of sites of a distributed computing environment. The plurality of components of the application may be identified based on (e.g., in response to) components information 152 of request 180, and the plurality of sites of a distributed computing environment may be identified based on (e.g., in response to) requirements information 154 of request 180.

In the example of FIG. 1, mapping determination instructions 122 may be configured to determine a plurality of mappings 130 of the components to the plurality of sites, wherein for each mapping, each component is mapped to a single site capable of satisfying at least one of the requirements. The requirements may comprise compute and storage requirements, such that for each mapping, compute and storage requirements of each component are capable of being satisfied by compute and storage resources at a single mapped site. Moreover, the requirements may comprise link latency requirements, such that for each mapping, each link latency requirement between the components is capable of being satisfied by a communication link between the sites. In some examples, the requirements may comprise both compute and storage requirements and link latency requirements.

In the example of FIG. 1, mapping selection instructions 124 may be configured to assign, for each mapping, a tier among a plurality of tiers of the SLA that corresponds to a most stringent requirement among the requirements that must be satisfied by the sites according to that mapping.

In examples described herein, a tier of an SLA may correspond to one or more core requirements of the SLA. Moreover, a tier of an SLA may comprise one or more latency requirements, one or more throughput requirements, one or more compute and storage requirements, one or more session density requirements (i.e., the number of users which can access one or more available services per unit area), or a combination thereof. Furthermore, each tier of the plurality of tiers may comprise one or more availability requirements associated with one or more core requirements. For instance, a first tier of an SLA, T₁, may provide that a deployed application will satisfy a core link latency requirement of ≤30 ms with an availability of ≥75% (i.e., each component of the deployed application will satisfy a link latency requirement of ≤30 ms with an availability of at least 75%), and a second tier of the SLA, T₂, may provide that the deployed application will satisfy the core link latency requirement of ≤30 ms with a core availability of ≥85%.

In examples described herein, a most stringent requirement may correspond a lowest latency requirement among latency requirements of the SLA, a highest throughput requirement among throughput requirements of the SLA, a highest compute and storage requirement among compute and storage requirements of the SLA, a highest session density requirement among session density requirements of the SLA, or a combination thereof. Furthermore, a most stringent requirement may correspond to one or more requirements of one or more components of the application (e.g., compute and storage requirements), one or more requirements between two or more components of the application (e.g. link latency requirements between two components), or a combination thereof. For instance, suppose that a link latency requirement L_{1,2} between the two components Y₁ and Y₂ of an application Y is the lowest latency requirement among all link latency requirements between the n components Y₁, Y₂, . . . Yₙ of application Y. In such example, the link latency requirement L_{1,2} may be determined to be the most stringent requirement of the SLA.

In the example of FIG. 1, mapping selection instructions 124 may be configured to order the mappings based on their assigned tiers. For instance, one mapping having a higher availability for the most stringent requirement than another mapping may be assigned to a lower order tier than that other mapping. Furthermore, in the event that two or more mappings have the same availability for a given most stringent requirement, mapping selection instructions 124 may select one of the mappings based on the availability of one or more other requirements of the SLA (among such mappings), based on the capabilities of the sites, based on a random or arbitrary ordering of such mappings, etc. For instance, in the example above, suppose that there two possible mappings of the components Y₁ and Y₂ of application Y to the sites, mappings M₁ and M₂, such that mapping M₁ satisfies link latency requirement L_{1,2} with an availability of at least 80%, and mapping M₂ satisfies link latency requirement L_{1,2} with an availability of at least 85%. In such example, mapping selection instructions 124 may assign mapping M₁ to a first tier of the SLA corresponding a core link latency requirement of ≥75%, and may assign mapping M₂ to a second tier of the SLA corresponding a core link latency requirement of ≥85%, wherein the second tier is a lower order tier than the first tier.

In the example of FIG. 1, mapping selection instructions 124 may be configured to select, among the mappings, a first mapping (selected mapping 132) that is assigned to the tier among the assigned tiers having a highest availability for the most stringent requirement. Moreover, mapping selection instructions 124 may select, among the mappings, the mapping assigned to a lowest order tier among the assigned tiers. For instance, in the example described above, since mapping M₂ has the highest availability for the most stringent requirement (link latency requirement L_{1,2}) among the mappings M₁ and M₂, mapping selection instructions 124 may be configured to select mapping M₂ (i.e., the lowest order tier).

In the example of FIG. 1, application deployment instructions 126 may be configured to deploy via an application deployment path 160 at least one of the components to the sites according to the first mapping. Application deployment path 160 may include any suitable communication link 162 (e.g., wired or wireless, direct or indirect, etc.) between MEC orchestrator 100 and one or more sites.

In examples described herein, an application deployment path may be a combination of hardware (e.g., communications interfaces, communication links, etc.) and instructions (e.g., executable by a processing resource) to communicate (e.g., receive, output, etc.) application deployment data to one or more sites in a computing environment.

In the example of FIG. 1, application deployment instructions 126 may be configured to deploy at least one of the components to the sites according to the first mapping by deploying, at each site, any components mapped to that site in an order based on a policy of the SLA. In addition, application deployment instructions 126 may be configured to deploy any components mapped to that site in an order based on the policy of the SLA, either until (i) all components mapped to that site have been deployed, or (ii) there are not enough available compute and storage resources at that site to deploy any additional components mapped to that site. This “site-limited” deployment approach assumes that all of the link throughput requirements between the components according to the SLA will be satisfied by communication links between the sites, but that there will be limited compute and storage resources at the sites to satisfy the compute and storage requirements of the components according to the SLA. In such examples, the policy of the SLA may be received from a client device. The policy of the SLA may specify the deployment order of the components based on one or more requirements of one or more components, based on one or more preferences of a client, etc. Optionally, the policy of the SLA may be determined by an OSS, by a device or system external to MEC orchestrator 100, or a combination thereof.

In the example of FIG. 1, application deployment instructions 126 may be configured to determine whether all of the components have been deployed to the sites according to first mapping. Based on (e.g., in response to) a determination that all of the components have not been deployed to the sites according to the first mapping, instructions 126 may be configured to undeploy all of the deployed components according to the first mapping. Based on (e.g., in response to) all of the deployed components according to the first mapping being undeployed, mapping selection instructions 124 may select a second mapping which is assigned to the tier among the assigned tiers having the second highest availability for the most stringent requirement. Based on (e.g., in response to) the selection of the second mapping, application deployment instructions 126 may be configured to deploy via an application deployment path 160 at least one of the components to the sites according to the second mapping.

In the example of FIG. 1, mapping selection instructions 124 may select a next lowest tier assigned mapping (e.g., third mapping, fourth mapping, etc.) based on a determination that all of the components have not been (or may not be) deployed to the sites according to any other lower tier assigned mapping(s). Based on (e.g., in response to) the selection of that next lowest tier assigned mapping, application deployment instructions 126 may be configured to deploy at least one of the components according to that next lowest tier assigned mapping.

In the example of FIG. 1, application deployment instructions 126 may be configured to determine, between the components, at least one tree mapping of a plurality of link throughput requirements according to the SLA, and for each tree mapping, establish communication links between the sites to satisfy the link throughput requirements between the components in an order based on a policy of the SLA. In addition, application deployment instructions 126 may establish communication links between the components in an order based on the policy of the SLA, either until (i) all communication links are established to satisfy the link throughput requirements between the components, or (ii) there is not enough available link throughput capacity between the sites to establish any additional communication links between the components. This “link-limited” deployment approach assumes that all of the compute and storage requirements of the components according to the SLA will be satisfied by the mapped sites, but that there will be limited link throughput capacity between the mapped sites to establish communication links between the components to satisfy the link throughput requirements according to the SLA. In such examples, the policy of the SLA may be received from a client device. The policy of the SLA may specify an order for establishing the communication links between the sites based on one or more requirements of one or more components, based on one or more preferences of a client, etc. Optionally, the policy of the SLA may be determined by an OSS, by a device or system external to MEC orchestrator 100, or a combination thereof.

In some examples, each tree mapping may comprise a tree having link throughput requirements between the components. Each tree mapping of link throughput requirements between the components may be determined by packing Steiner trees to a selected mapping. In such examples, the communication links between the sites may be established to establish links between deployed components of the application. Alternatively, the communication links may be established between the sites to satisfy throughput requirements between the components, but not to establish links between deployed components (i.e., the components do not need to be deployed to the sites to establish communication links between the sites to satisfy throughput requirements according to the SLA).

In the example of FIG. 1, application deployment instructions 126 may be configured to determine whether all communication links have been established to satisfy the link throughput requirements between the components according to the first mapping. Based on (e.g., in response to) a determination that all communication links have not been established to satisfy the link throughput requirements between the components according to the first mapping, mapping selection instructions 124 may be configured to select a second mapping which is assigned to the tier among the assigned tiers having the second highest availability for the most stringent requirement. Based on (e.g., in response to) the selection of the second mapping, application deployment instructions 126 may be configured to deploy via an application deployment path 160 at least one of the components to the sites according to the second mapping.

In the example of FIG. 1, mapping selection instructions 124 may select a next lowest tier assigned mapping (e.g., third mapping, fourth mapping, etc.) based on (e.g., in response to) a determination that that all communication links have not been (or may not be) established to satisfy the link throughput requirements between the components according to any lower tier assigned mappings. Based on (e.g., in response to) the selection of that next lowest tier assigned mapping, application deployment instructions 126 may be configured to deploy at least one of the components according to that next lowest tier assigned mapping.

In this manner, MEC orchestrator 100 ensures that an application may be deployed in a distributed computing environment to comply with core requirements of an SLA. For example, in such examples, MEC orchestrator 100 may assign, for each mapping, a tier among a plurality of tiers of the SLA that corresponds to a most stringent requirement among the requirements that must be satisfied by the sites according to that mapping, and select among the mappings, a first mapping that is assigned to the tier among the assigned tiers having a highest availability for the most stringent requirement, thereby ensuring that the selected mapping of the components to the plurality of sites may satisfy the core requirements of the SLA. Moreover, MEC orchestrator 100 may deploy at least one of the components to the sites according to a first mapping, thereby ensuring that each of the deployed components will satisfy the core requirements of the SLA. Furthermore, under a site-limited deployment approach, MEC orchestrator 100 may determine whether all of the components have been deployed to the sites according to a selected mapping, and based on a determination that all of the components have not been deployed to the sites according to the selected mapping, undeploy all the deployed components and select another mapping to deploy the applications, thereby ensuring that the application remains deployed according to a mapping only if the storage and compute requirements of the SLA are satisfied. Alternatively, under a link-limited deployment approach, MEC orchestrator 100 may determine whether all communication links have been established to satisfy link throughput requirements between the components according to a selected mapping, and based on a determination that all communication links have not been established according to the selected mapping, selecting another mapping for deploying the applications, thereby ensuring that the application will be deployed based on a mapping which satisfies the link throughput requirements of the SLA.

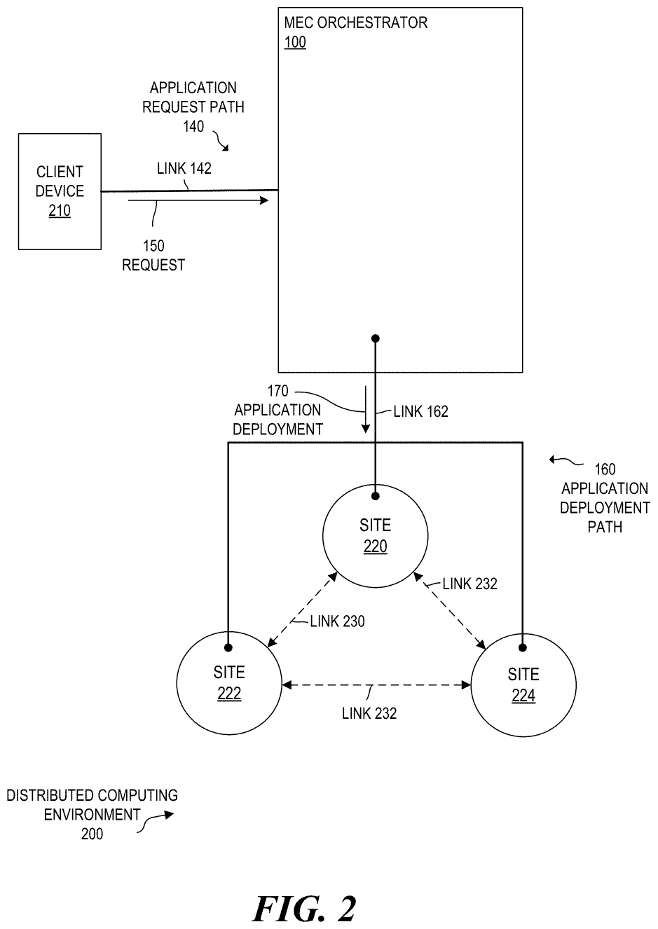

FIG. 2 is a block diagram of an example distributed computing environment 200 including an MEC orchestrator for deploying an application. Distributed computing environment 200 may include MEC orchestrator 100, as described above in relation to FIG. 1. In some examples, distributed computing environment 200 may comprise an MEC system. In such examples, the MEC system may comprise an MEC system level management system, an MEC host level management system, one or more MEC hosts each comprising an MEC platform, a virtualization infrastructure and one or more MEC applications or components of applications, and one or more network entities.

In examples described herein, an MEC platform may comprise a computing environment, wherein applications and/or components of applications deployed on the computing environment may discover, advertise, consume, and/or offer MEC services (e.g., applications), including MEC services which may be available on other platforms in a same and/or different MEC system.

In examples described herein, a virtualization architecture may comprise compute, storage, and/or networking resources for running one or more applications and/or components of applications. In some examples, a virtualization architecture may include a data plane that executes traffic rules received by an MEC platform, and may route the traffic among one or more applications or components of applications, services, one or more DNS servers and/or proxies, other networks (local or external), or a combination thereof.

In examples described herein, a network entity may comprise one or more networks, such as a LAN, VLAN, wide area network (WAN) (e.g., the Internet), a cellular network (e.g., 3G, 4G, 5G, etc.), or a combination thereof.

In the example of FIG. 2, distributed computing environment 200 may include sites 220, 222, and 224. Each of sites 220, 222, and 224 may comprise compute and storage resources which are connected to a unique Layer 2 (L2) network. For example, each of sites 220, 222, and 224 may comprise unique compute and storage resources which are connected to a local area network (LAN) or a virtual local area network (VLAN). Moreover, each of sites 220, 222, and 224 may be located at a unique location at an edge of the distributed computing environment. In the example of FIG. 2, each of sites 200, 222, 224 may be connected to a centralized cloud or data center (not shown) of distributed computing environment 200 via one or more communication links.

In examples described herein, a centralized cloud may refer to one or more compute and storage resources which may be shared over a network, typically over the Internet. In examples described herein, a centralized data center may refer to one or more physical locations which comprise compute and storage resources which are shared over a network. Moreover, a centralized cloud or data center may refer to one or more locations within a distributed computing environment (e.g., a MEC system).

In the example of FIG. 2, sites 220, 222, and 224 may comprise a plurality of communication links 230, 232, and 234 between the sites. In such examples, each of communication links 230, 232, 234 may include any one or more suitable communication links (e.g., wired or wireless, direct or indirect, etc.) between the sites. Moreover, each of communication links 230, 232, and 234 may use any suitable data transmission protocol(s), including at least one connection-oriented protocol such as TCP, at least one connectionless protocol such as UDP, or the like, or a combination thereof. It will be understood by one skilled in the art that each of communication links 230, 232, 234 may use any suitable type(s) of communication link(s) and/or suitable type(s) of data transmission protocol(s), now known or later developed.

In the example of FIG. 2, distributed computing environment may include client device 210. Client device may comprise one or more computing devices comprising at least one processing resource and at least one machine-readable storage medium comprising instructions configured to transmit request 150 to MEC orchestrator 100 via application request path 140. Optionally, client device 210 may be configured to transmit request 150 to MEC orchestrator 100 via a CFS portal. Furthermore, client device 210 may comprise one or more device applications running on a cloud network (e.g., a centralized cloud), wherein MEC orchestrator 100 may receive application request 150 from one or more device applications of client device 210 via application request path 140.

In the example of FIG. 2, each of sites 220, 222, and 224 may comprise an MEC host including an MEC platform and a virtualization infrastructure. Moreover, although FIG. 2 shows distributed computing environment 200 comprising three sites 220, 222, and 224, it will be understood by one skilled in the art that distributed computing environment 200 may comprise any number of sites.

In the example of FIG. 2, mapping determination instructions 122 may be configured to receive a request 150 from client device 210 via an application request path 140 to deploy an application according to a plurality of requirements of an SLA.

In the example of FIG. 2, mapping determination instructions 122 may be configured to, in response to the request, identify a plurality of components of the application and a plurality of sites (e.g., sites 220, 222, 224) of distributed computing environment 200.

In the example of FIG. 2, mapping determination instructions 122 may be configured to determine a plurality of mappings 130 of the components to the plurality of sites (e.g., sites 220, 222, and 224), wherein for each mapping, each component is mapped to a single site capable of satisfying at least one of the requirements. In some examples, the requirements may comprise compute and storage requirements, such that for each mapping, compute and storage requirements of each component are capable of being satisfied by compute and storage resources at a single mapped site. In some examples, the requirements may comprise link latency requirements, such that for each mapping, each link latency requirement between the components is capable of being satisfied by a communication link between the sites. In some examples the requirements may comprise both compute and storage requirements and link latency requirements.

In the example of FIG. 2, mapping selection instructions 124 may be configured to assign, for each mapping, a tier among a plurality of tiers of the SLA that corresponds to a most stringent requirement among the requirements that must be satisfied by the sites according to that mapping. Moreover, each tier of the plurality of tiers may comprise one or more core availability requirements associated with one or more of the requirements.

In the example of FIG. 2, mapping selection instructions 124 may be configured to select, among the mappings, a first mapping (selected mapping 132) that is assigned to the tier among the assigned tiers having a highest availability for the most stringent requirement.

In the example of FIG. 2, application deployment instructions 126 may be configured to deploy via an application deployment path 160 at least one of the components to the sites 220, 222, and 224 according to the first mapping.

In the example of FIG. 2, application deployment instructions 126 may be configured to deploy at least one of the components to the sites according to the first mapping by deploying, at each site, any components mapped to that site in an order based on a policy of the SLA, either until (i) all components mapped to that site have been deployed, or (ii) there are not enough available compute and storage resources at that site to deploy any additional components mapped to that site.

In the example of FIG. 2, application deployment instructions 126 may be configured to determine whether all of the components have been deployed to the sites 220, 222, and 224 according to the first mapping. Based on (e.g., in response to) a determination that all of the components have not been deployed to the sites 220, 222, and 224 according to the first mapping, instructions 126 may be configured to undeploy all of the deployed components according to the first mapping. Based on (e.g., in response to) all of the deployed components according to the first mapping being undeployed, mapping selection instructions 124 may be configure to select a second mapping which is assigned to the tier among the assigned tiers having the second highest availability for the most stringent requirement. Based on (e.g., in response to) the selection of the second mapping, application deployment instructions 126 may be configured to deploy via an application deployment path 160 at least one of the components to the sites 220, 222, and 224 according to the second mapping.

In the example of FIG. 2, mapping selection instructions 124 may be configured to select a next lowest tier assigned mapping (e.g., third mapping, fourth mapping, etc.) based a determination that all of the components have not been (or may not be) deployed to the sites 220, 222, and 224 according to any other lower tier assigned mapping(s). Based on (e.g., in response to) the selection of that next lowest tier assigned mapping, application deployment instructions 126 may be configured to deploy at least one of the components according to that next lowest tier assigned mapping.

In the example of FIG. 2, application deployment instructions 126 may be configured to determine, between the components, at least one tree mapping of a plurality of link throughput requirements according to the SLA, and for each tree mapping, establish communication links between the sites 220, 222, and 224 to satisfy the link throughput requirements between the components in an order based on a policy of the SLA, either until (i) all communication links are established to satisfy the link throughput requirements between the components, or (ii) there is not enough available link throughput capacity between the sites 220, 222, and 224 to establish any additional communication links between the components. In some examples, the communication links between the sites may be established to establish links between deployed components of the application. Alternatively, the communication links may be established between the sites to satisfy throughput requirements between the components, but not to establish links between deployed components (i.e., the components do not need to be deployed to the sites to establish communication links between the sites to satisfy throughput requirements according to the SLA).

In the example of FIG. 2, application deployment instructions 126 may be configured to determine whether all communication links have been established to satisfy the link throughput requirements between the components according to the first mapping. Based on (e.g., in response to) a determination that all communication links have not been established to satisfy the link throughput requirements between the components according to the first mapping, mapping selection instructions 124 may be configured to select the tier among the assigned tiers having the second highest availability for the most stringent requirement. Based on (e.g., in response to) the selection of the second mapping, application deployment instructions 126 may be configured to deploy via an application deployment path 160 at least one of the components to the sites according to the second mapping.

In the example of FIG. 2, mapping selection instructions 124 may select a next lowest tier assigned mapping (e.g., third mapping, fourth mapping, etc.) based on (e.g., in response to) a determination that that all communication links have not been (or may not be) established to satisfy the link throughput requirements between the components according to any lower tier assigned mappings. Based on (e.g., in response to) the selection of that next lowest tier assigned mapping, application deployment instructions 126 may be configured to deploy at least one of the components according to that next lowest tier assigned mapping.

In this manner, MEC orchestrator 100 ensures that the application may be deployed to sites 220, 222, and 224 of distributed computing environment 200 to comply with core requirements of an SLA. For example, in such examples, MEC orchestrator 100 may assign, for each mapping, a tier among a plurality of tiers of the SLA that corresponds to a most stringent requirement among the requirements that must be satisfied by the sites 220, 222, and 224 according to that mapping, and select among the mappings, a first mapping that is assigned to the tier among the assigned tiers having a highest availability for the most stringent requirement, thereby ensuring that the selected mapping of the components to the plurality of sites 220, 222, and 224 may satisfy the core requirements of the SLA. Furthermore, under a site-limited deployment approach, MEC orchestrator 100 may determine whether all of the components have been deployed to the sites 220, 222, and 224 according to a selected mapping, and based on a determination that all of the components have not been deployed to the sites 220, 222, and 224 according to the selected mapping, undeploy all the deployed components and select another mapping to deploy the applications, thereby ensuring that the application remains deployed according to a mapping only if the compute and storage requirements of the SLA are satisfied. Alternatively, under a link-limited deployment approach, MEC orchestrator 100 may determine whether all communication links have been established to satisfy link throughput requirements between the components according to a selected mapping, and based on a determination that all communication links have not been established according to the selected mapping, selecting another mapping for deploying the applications, thereby ensuring that the application will be deployed based on a mapping which satisfies the link throughput requirements of the SLA.

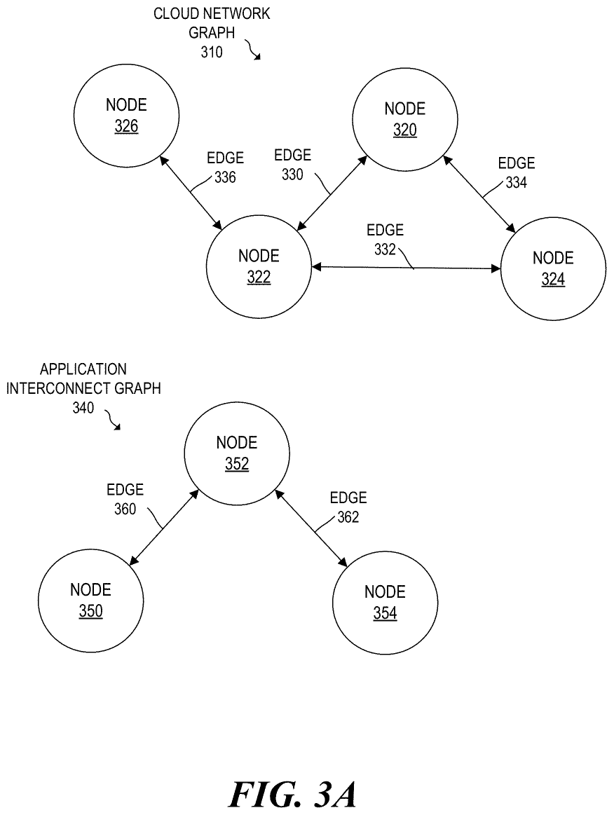

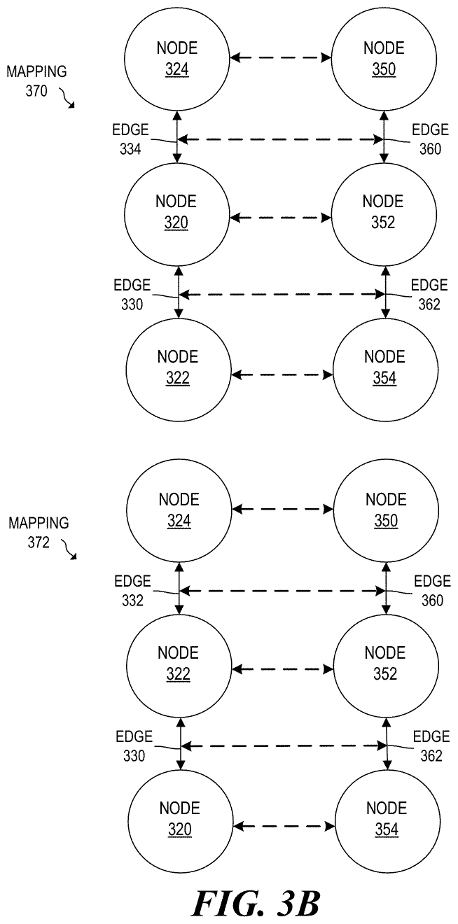

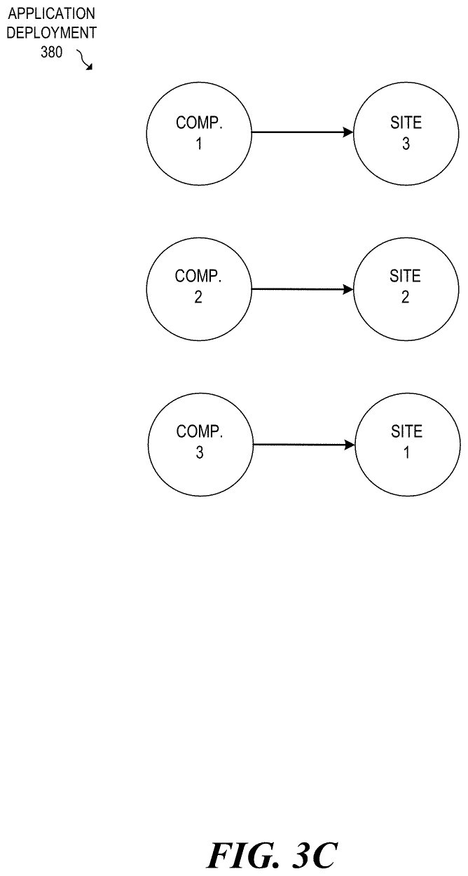

FIGS. 3A to 3C are block diagrams which show an example deployment by an MEC orchestrator of an application in a distributed computing environment. FIG. 3A shows an example cloud network graph (CNG) 310 and an example application interconnect graph (AIG) 340. FIG. 3B shows an example mappings 370 and 372 of CNG 310 to AIG 340. FIG. 3C shows an example application deployment 380 based on mapping 372. The MEC orchestrator may comprise MEC orchestrator 100, as described above in relation to FIGS. 1 and 2. The distributed computing environment may comprise computing environment 200, as described above in relation to FIG. 2.

In the example of FIGS. 3A to 3C, the distributed computing environment comprises a MEC system comprising four sites, wherein each site comprises compute and storage resources which are located at a unique location at an edge of the distributed computing environment and wherein each site is connected to a unique L2 network. Moreover, the distributed computing environment comprises a first communication link between the first and second sites, a second communication link between the second and third sites, a third communication link between the first and third sites, and a fourth communication link between the second and fourth sites.

In the example of FIGS. 3A to 3C, the MEC orchestrator identifies network information about the sites of the distributed computing environment and about the communication links between the sites. For instance, the MEC orchestrator may receive a request which includes a cloud network graph (CNG) 310 and/or information based on CNG 310 (as shown in FIG. 3A). Moreover, the MEC orchestrator may access data comprising the network information from a storage location (e.g., one or more physical storage locations or volatile memory) of the MEC system.

In examples described herein, a CNG is a graphical or logical representation of sites of a distributed computing environment and communication links between the sites. In a CNG, each site of the distributed computing environment may be represented as a node, and each communication link between two sites may be represented as an edge between two nodes. Moreover, each node of a CNG may comprise one or more associated values which represent a site capacity (compute and storage resources, compute and storage availability, etc.) for a given site. Furthermore, each edge of a CNG may comprise one or more associated values which represent a link capacity (e.g., throughput capacity, latency capacity, throughput capacity availability, latency capacity availability, etc.) for a given communication link. In addition, each of the associated values for the nodes and edges of the CNG may be weighted based on the capacities of one or more sites or one or more communication links.

As shown in FIG. 3A, CNG 310 comprises first, second, third, and fourth nodes 320, 322, 324, and 326 which represent the first, second, third, and fourth sites of the distributed computing environment, respectively. Moreover, as shown in FIG. 3A, CNG 310 comprises a first edge 330 between first and second nodes 320 and 322 to represent the first communication link between the first and second sites, a second edge 332 between second and third nodes 322 and 324 to represent the second communication link between the second and third sites, a third edge 334 between first and third nodes 320 and 324 to represent the third communication link between the first and third sites, and a fourth edge 336 between second and fourth nodes 322 and 326 to represent the fourth communication link between the second and fourth sites. Furthermore, each of nodes 320-326 has a weighted value that represents a compute and storage capacity (i.e., a capacity of compute and storage resources) of the represented site, and each of edges 330-336 has a weighted value that represents a link latency capacity of the represented communication link.

Table 1 below shows the weighted values which are assigned to nodes 320-326 and edges 330-336 of CNG 310 to represent the compute and storage capacities of the sites and the link latency capacities of the communication links. In such example, a higher value assigned to a given node represents a higher compute and storage capacity for that node, and a higher value assigned to a given edge represents a lower link latency (i.e., faster) capacity for that communication link.

TABLE 1

| Node | Compute and Storage Capacity |
|---|---|
| Node 320 | 6 |
| Node 322 | 5 |
| Node 324 | 15 |
| Node 326 | 2 |
| Edge | Link Latency Capacity |
| Edge 330 | 2 |
| Edge 332 | 3 |
| Edge 334 | 4 |
| Edge 336 | 1 |

In the example of FIGS. 3A to 3C, the MEC orchestrator receives a request to deploy an application according to a plurality of requirements of an SLA. The request comprises components information and requirements information which identify the components of the application and link requirements between the sites according to the SLA, respectively. The components information and requirements information includes an application interconnect graph (AIG) 340 and/or information based on AIG 340. The MEC orchestrator may receive data comprising the components information and requirements information from a CFS portal or from a client device application.

In examples described herein, an AIG is a graphical or logical representation of components of an application and logical links between the components. In an AIG, each component of the application may be represented as a node, and each logical link between two components may be represented as an edge between two nodes. Moreover, each node of an AIG may comprise one or more associated values which represent a component requirement (compute and storage requirements, compute and storage availability requirements, etc.) for a given component. Furthermore, each edge of an AIG may comprise one or more associated values which represent a link requirement (e.g., throughput requirement, latency requirement, link throughput availability requirement, link latency availability requirement, etc.) for a given logical link. In addition, each of the associated values for the nodes and edges of the AIG may be weighted based on the requirements of one or more components or one or more logical links.

As shown in FIG. 3A, AIG 340 comprises first, second, and third nodes 350, 352, and 354 which represent the first, second, and third components of the application, respectively. Moreover, as shown in FIG. 3A, AIG 340 comprises a first edge 360 between first and second nodes 350 and 352 to represent the first logical link between the first and second components, and a second edge 362 between second and third nodes 352 and 354 to represent the second logical link between the second and third components. Furthermore, each of the nodes 350-354 has an associated weighted value that represents compute and storage requirements of the represented component, and each of the edges 360 and 362 has an associated weighted value that represents a link latency requirement of the represented logical link.

For example, Table 2 below shows weighted values which are assigned to nodes 350-354 and edges 360 and 362 of AIG 340 to represent the compute and storage requirements of the components and the link latency requirements of the communication links. In such example, a higher value assigned to a given node represents a higher compute and storage requirement for that node, and a higher value assigned to a given edge represents a lower link latency (i.e., faster) requirement for that communication link.

TABLE 2

| Node | Compute and Storage Requirement |
|---|---|
| Node 350 | 12 |
| Node 352 | 4 |
| Node 354 | 4 |
| Edge | Link Latency Requirement |
| Edge 360 | 3 |
| Edge 362 | 2 |

In the example of FIGS. 3A to 3C, the MEC orchestrator determines mappings of the components of the application to sites of the distributed computing environment to satisfy the requirements of the SLA. As shown in FIG. 3B, for the compute and storage capacities of the sites and the link latency capacities of the communication links according to Table 1 above, and for the compute and storage requirements of the components and the link latency requirements of the communication links according to Table 2 above, the MEC orchestrator determines two possible mappings 370 and 372 of nodes and edges of CNG 310 to nodes and edges of AIG 340 which satisfy the requirements.

In the example of FIGS. 3A to 3C, the first logical link between the first and second components of the application (represented as edge 360 in AIG 340) has a most stringent link latency requirement among the link latency requirements between the components of the application (as shown in Table 2). Moreover, suppose that each of two tiers of the SLA has a core link latency availability requirement: a first tier (Tier 1) has a core link latency availability requirement of ≥95%, and a second tier (Tier 2) has a core link latency availability requirement of at least ≥85%.

Accordingly, in the example of FIGS. 3A to 3C, the MEC orchestrator assigns, for each mapping 370 and 372, one of the two tiers of the SLA that corresponds to the link latency requirement for edge 360. For instance, suppose that in the example of FIGS. 3A to 3C, the third communication link between the first and fourth sites (represented as edge 334 in CNG 310) can satisfy the link latency requirement for the second logical link between the second and third components (represented as edge 362 in AIG 340) with an availability of at least 90%, and that the first communication link between the first and second sites (represented as edge 330 in CNG 310) can satisfy the link latency requirement for the second logical link between the second and third components (represented as edge 362 in AIG 340) with an availability of at least 99.9%. In such example, the MEC orchestrator assigns mapping 372 to Tier 1 (since mapping 372 satisfies a core link latency availability requirement of at least 95%) and mapping 370 to Tier 2 (since mapping 370 satisfies a core link latency availability requirement of at least 85%), such that Tier 1 is a lower order tier than Tier 2.

In the example of FIG. 3A to 3C, the MEC orchestrator selects, among the mappings 370 and 372, a first mapping (mapping 372) which is assigned to the tier (Tier 1) among the assigned tiers (Tier 1, Tier 2) having a highest availability for a most stringent requirement (the link latency requirement for the first logical link). In other words, the MEC orchestrator selects, among the mappings, mapping 372 which is assigned to the lowest order tier (Tier 1) among the assigned tiers (Tier 1, Tier 2).

In the example of FIGS. 3A to 3C, the MEC orchestrator performs application deployment 380 according to mapping 372, i.e., such that the first component is deployed on the third site, the second component is deployed to the second site, and the third component is deployed to the first site.

In this manner, the MEC orchestrator ensures that an application may be deployed in a distributed computing environment to comply with core requirements of an SLA. For example, in the example of FIGS. 3A to 3C, the MEC orchestrator assigns, for each mapping 370 and 372, a tier among a plurality of tiers (Tier 1, Tier 2) of the SLA that corresponds to a most stringent requirement (the link latency requirement for the first logical link) among the requirements that must be satisfied by the sites according to that mapping, and selects among the mappings, a first mapping (mapping 372) that is assigned to the tier (Tier 1) among the assigned tiers (Tier 1, Tier 2) having the highest availability for that most stringent requirement, thereby ensuring that the selected mapping of the components to the plurality of sites may satisfy the core requirements of the SLA are satisfied. Moreover, MEC orchestrator deploys the components to the sites according to the first mapping (mapping 372), thereby ensuring that each of the deployed components will satisfy the core requirements of the SLA.

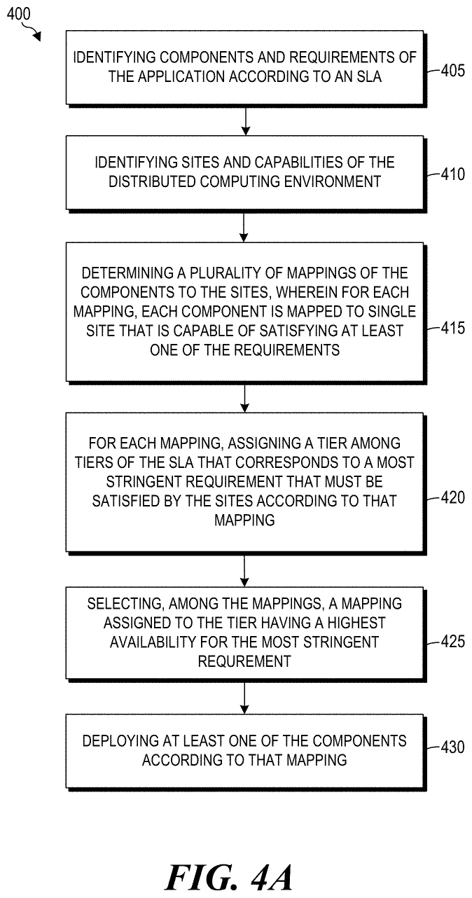

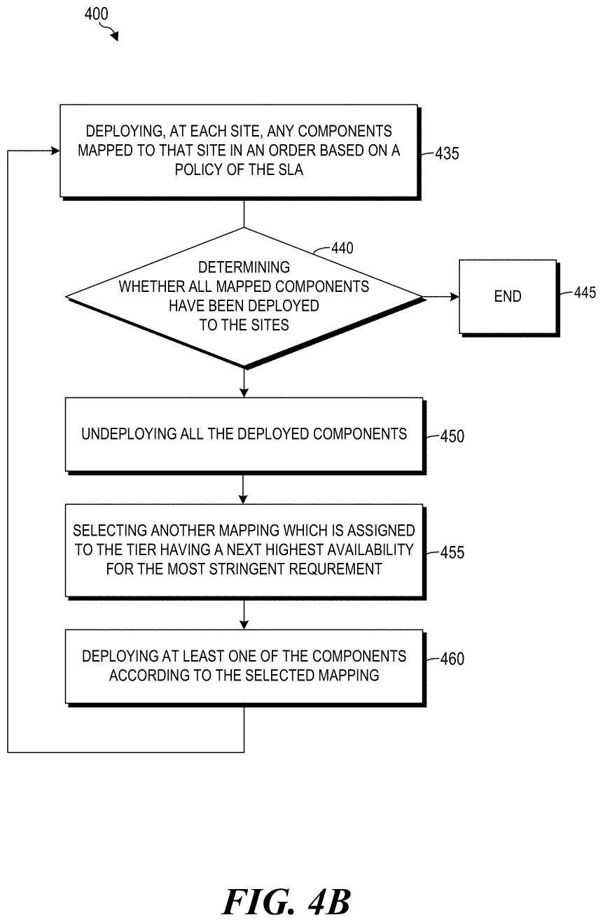

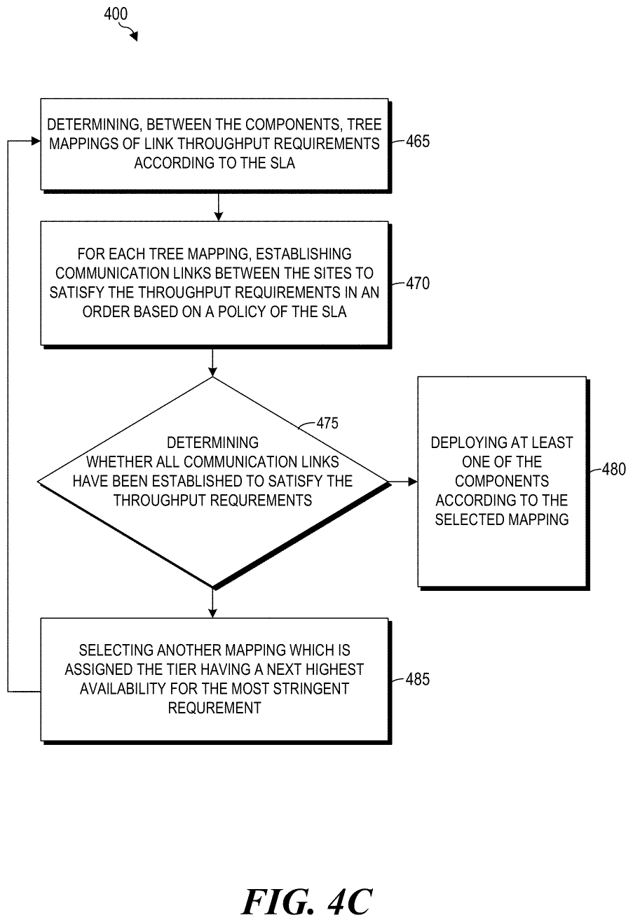

FIGS. 4A to 4C shows an example functionality 400 to deploy an application in a distributed computing environment. Functionality 400 may be implemented as a method or may be executed as one or more instructions on a machine (e.g., by at least one processor), where the one or more instructions are included on at least one machine-readable storage medium (e.g., a non-transitory machine readable-storage medium.) While only seventeen blocks are shown in functionality 400, functionality 400 may include other actions described herein. Additionally, although the blocks are shown in an order, blocks depicted in FIG. 4 may be performed in any order and at any time. Also, some of the blocks shown in functionality 400 may be omitted without departing from the spirit and scope of this disclosure. Functionality 400 may be implemented on a network device according to any of the examples herein.

As shown in block 405, functionality 400 may include identifying a plurality of components of the application and a plurality of requirements of the application according to an SLA. The plurality of requirements may comprise compute and storage requirements, link latency requirements, or a combination thereof. Moreover, the components and requests of the application may be identified by receiving, from a client, a request to deploy the application, wherein the request comprises components information and requirements information of the application.

As shown in block 410, functionality 400 may include identifying sites and capabilities of the distributed computing environment. The identified capabilities may include compute and storage resources at each site, link latency capacities for each communication link between the sites, or a combination thereof. Optionally, the identified capabilities may include link throughput capacities for each communication link between the sites. Optionally, the sites and the capabilities of the distributed computing environment may be identified by receiving (e.g., by the MEC orchestrator) site information and capability information from a client via a CFS portal or device application in a MEC system. Moreover, the sites and the capabilities of the distributed computing environment may be identified by accessing, from a storage location (e.g., physical storage or volatile memory) of the MEC system, the site information and capability information.

As shown in block 415, functionality 400 may include determining a plurality of mappings of the components to the plurality of sites, wherein for each mapping, each component is mapped to a single site capable of satisfying at least one of the requirements. Each mapping may be determined so that compute and storage requirements of each component are capable of being satisfied by compute and storage resources at a single mapped site, and so that each link latency requirement between the components is capable of being satisfied by a link latency capacity of a communication link between the mapped sites.

As shown in block 420, functionality 400 may include assigning, for each mapping, a tier among a plurality of tiers of the SLA that corresponds to a most stringent requirement among the requirements that must be satisfied by the sites according to that mapping. Each tier of the plurality of tiers may correspond to one or more core requirements of the SLA. Each tier of the plurality of tiers may comprise one or more latency requirements, one or more throughput requirements, one or more compute and storage requirements, one or more session density requirements, or a combination thereof. Furthermore, each tier of the plurality of tiers may comprise one or more availability requirements associated with one or more core requirements. In some examples, a most stringent requirement may correspond to a lowest latency requirement among latency requirements of the SLA, a highest throughput requirement among throughput requirements of the SLA, a highest compute and/or storage requirement among compute and storage requirements of the SLA, a highest session density requirement among session density requirements of the SLA, or a combination thereof.

As shown in block 425, functionality 400 may include selecting, by the processing resource among the mappings, a mapping (e.g., a first mapping) that is assigned to the tier among the assigned tiers having a highest availability for the most stringent requirement. The selected mapping may be assigned to a lowest order tier among the assigned tiers.

As shown in block 430, functionality 400 may include deploying at least one of the components to the sites according to the selected mapping (e.g., the first mapping). In some examples, all of the components may be deployed to the sites based on (e.g., in response to) a determination that there are enough available compute and storage resources at the sites to deploy all components mapped to the sites.

FIG. 4B shows an example functionality 400 of an MEC orchestrator to deploy an application in a distributed computing environment based on a site-limited deployment approach.

As shown in block 435, functionality 400 may include deploying, at each site, any components mapped to that site (e.g., according to the first mapping) in an order based on a policy of the SLA. Furthermore, the components may be deployed to each site, either until (i) all components mapped to that site have been deployed, or (ii) there are not enough available compute and storage resources at that site to deploy any additional components mapped to that site.

As shown in block 440, functionality 400 may include determining whether all of the mapped components (e.g., according to the first mapping) have been deployed to the sites. At block 440, if it is determined that all of the components have been deployed to the sites, then functionality 400 proceeds to block 445. At block 440, if it is determined that all of components have not been deployed to the sites, then functionality 400 proceeds to block 450.

As shown in block 445, functionality 400 may include ending the deployment of the application. Ending the deployment may comprise receiving (e.g., by the MEC orchestrator) an indication that all components of the application have been deployed.

As shown in block 450, based on (e.g., in response to) a determination that all of the components have not been deployed to the sites (e.g., according to the first mapping), functionality 400 may include undeploying all of the deployed components. Undeploying all the deployed components may comprise terminating all communication links which have been established between the deployed components.

As shown in block 455, based on (e.g., in response to) a determination that all of the deployed components have been undeployed (e.g., according to the first mapping), functionality 400 may include selecting another mapping (e.g., a second mapping) that is assigned to the tier among the assigned tiers having a next highest availability for the most stringent requirement. The selected other mapping may have a next lowest order tier among the assigned tiers.

As shown in block 460, based on (e.g., in response to) a selection of the mapping (e.g., the second mapping), functionality may include deploying at least one of the components according to that the selected mapping. In some examples, functionality 400 may then proceed to block 435 (e.g., functionality 400 may include deploying, at each site, any components mapped to that site based on the second mapping in an order based on a policy of the SLA).

In the example of FIG. 4B, functionality 400 may include selecting a next lowest tier assigned mapping based a determination that all of the components have not been deployed to the sites according to any other lower tier assigned mapping. Based on (e.g., in response to) the selection of that next lowest tier assigned mapping, functionality 400 may include deploying at least one of the components according to that next lowest tier assigned mapping.

FIG. 4C shows an example functionality 400 of an MEC orchestrator to deploy an application in a distributed computing environment based on a link-limited deployment approach.

As shown in block 465, functionality 400 may include determining, between the components, at least one tree mapping of link throughput requirements, wherein the link throughput requirements are according to the SLA. Each tree mapping of link throughput requirements between the components may be determined by packing Steiner trees to the selected mapping (e.g., the first mapping).

As shown in block 470, functionality 400 may include, for each tree mapping, establishing communication links between the sites to satisfy the link throughput requirements between the components in an order based on a policy of the SLA. Furthermore, for each tree mapping, the communication links may be established between the sites either until (i) all communication links are established to satisfy the link throughput requirements between the components, or (ii) there is not enough available link throughput capacity between the sites to establish any additional communication links between the components.

As shown in block 475, functionality 400 may include determining whether all communication links have been established to satisfy the link throughput requirements between the components (e.g., according to the first mapping). At block 475, if it is determined that all communication links have been established to satisfy the link throughput requirements, then functionality 400 proceeds to block 480. At block 475, if it is determined that all communication links have not been established to satisfy the link throughput requirements, then functionality 400 proceeds to block 485.

As shown in block 480, functionality 400 may include deploying at least one of the components to the sites according to the selected mapping (e.g., according to the first mapping). In some examples, functionality 400 may include deploying all of the components to the sites (e.g., according to the first mapping). Based on (e.g., in response to) all the components being deployed to the sites, functionality 400 may include receiving (e.g., by the MEC orchestrator) an indication that all components of the application have been deployed.

As shown in block 485, functionality 400 may include selecting another mapping (e.g., a second mapping) that is assigned to the tier among the assigned tiers having a next highest availability for the most stringent requirement. The selected other mapping may have a next lowest order tier among the assigned tiers. In some examples, functionality 400 may then proceed to block 465 (e.g., functionality 400 may include determining, between the components, at least one tree mapping of link throughput requirements according to the second mapping, wherein the link throughput requirements are according to the SLA).

In the example of FIG. 4C, functionality 400 may include selecting a next lowest tier assigned mapping based on (e.g., in response to) a determination that all communication links have not been established to satisfy the link throughput requirements between the deployed components according to any lower tier assigned mappings. Based on (e.g., in response to) the selection of that next lowest tier assigned mapping, functionality 400 may include deploying at least one of the components according to that next lowest tier assigned mapping.

In this manner, example functionality 400 of FIG. 4 ensures that an application may be deployed in a distributed computing environment to comply with core requirements of an SLA. For instance, functionality 400 may include assigning, for each mapping, a tier among a plurality of tiers of the SLA that corresponds to a most stringent requirement among the requirements that must be satisfied by the sites according to that mapping, and selecting, among the mappings, a mapping (e.g., a first mapping) that is assigned to the tier among the assigned tiers having a highest availability for the most stringent requirement, thereby ensuring that the selected mapping of the components to the plurality of sites may satisfy the core requirements of the SLA. Moreover, functionality 400 may include deploying, at each site, any components mapped to that site in an order based on a policy of the SLA, and based on a determination that all the mapped components have not been deployed to the sites, undeploying all of the deployed components, selecting another mapping (e.g., a second mapping) that is assigned to the tier among the assigned tiers having a next highest availability for the most stringent requirement, and deploying at least one of the components according to that other mapping, thereby ensuring that the application will remain deployed only if all the deployed components satisfy the compute and storage requirements of the SLA. Furthermore, functionality 400 may include establishing communication links between the sites to satisfy throughput requirements based on a policy of the SLA, and based on a determination that all communication links have not been established to satisfy the throughput requirements, selecting another mapping (e.g., a second mapping) that is assigned to the tier among the assigned tiers having a next highest availability for the most stringent requirement, and deploying at least one of the components according to that other mapping, thereby ensuring that the application will only be deployed if all the components satisfy the link throughput requirements of the SLA.

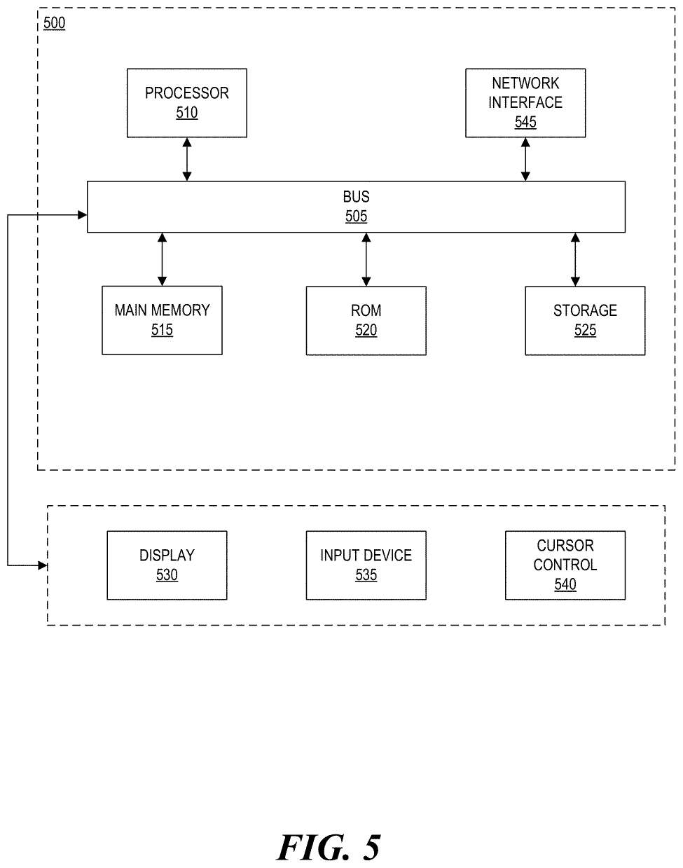

FIG. 5 is a block diagram of an example computer system 500 in which various embodiments described herein may be implemented for deploying an application in a distributed computing environment.

Computer system 500 includes bus 505 or other communication mechanism for communicating information, at least one hardware processor 510 coupled with bus 505 for processing information. At least one hardware processor 510 may be, for example, at least one general purpose microprocessor.

Computer system 500 also includes main memory 515, such as random access memory (RAM), cache, other dynamic storage devices, or the like, or a combination thereof, coupled to bus 505 for storing information and one or more instructions to be executed by at least one processor 510. Main memory 515 also may be used for storing temporary variables or other intermediate information during execution of one or more instructions to be executed by at least one processor 510. Such one or more instructions, when stored on storage media accessible to at least one processor 510, render computer system 500 into a special-purpose machine that is customized to perform the operations specified in the one or more instructions.

Computer system 500 may further include read only memory (ROM) 520 or other static storage device coupled to bus 505 for storing static of one or more instructions to be executed by at least one processor 510. Such one or more instructions, when stored on storage media accessible to at least one processor 510, render computer system 500 into a special-purpose machine that is customized to perform the operations specified in the one or more instructions.

Computer system 500 may further include information and one or more instructions for at least one processor 510. At least one storage device 525, such as a magnetic disk, optical disk, or USB thumb drive (Flash drive), or the like, or a combination thereof, may be provided and coupled to bus 505 for storing information and one or more instructions.

Computer system 500 may further include display 530 coupled to bus 505 for displaying a graphical output to a user. The computer system 500 may further include input device 535, such as a keyboard, camera, microphone, or the like, or a combination thereof, coupled to bus 505 for providing an input from a user. Computer system 500 may further include cursor control 540, such as a mouse, pointer, stylus, or the like, or a combination thereof, coupled to bus 505 for providing an input from a user.

Computer system 500 may further includes at least one network interface 545, such as a network interface controller (NIC), network adapter, or the like, or a combination thereof, coupled to bus 505 for connecting computer system 500 to at least one network.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked based on (e.g., in response to) detected events or interrupts. Software components configured for execution on computing devices may be provided on a computer readable medium, such as a compact disc, digital video disc, flash drive, magnetic disc, or any other tangible medium, or as a digital download (and may be originally stored on a compressed or installable format that requires installation, decompression or decryption prior to execution.) Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 based on (e.g., in response to) at least one processor 510 executing one or more sequences of one or more instructions contained in main memory 515. Such one or more instructions may be read into main memory 515 from another storage medium, such as at least one storage device 525. Execution of the sequences of one or more instructions contained in main memory 515 causes at least one processor 510 to perform the process steps described herein. In alternative embodiments, hard-wired circuitry may be used in place of or in combination with software instructions.

In examples described herein, a communication link may use any suitable data transmission protocol(s), including at least one connection-oriented protocol such as Transmission Control Protocol (TCP), at least one connectionless protocol such as User Datagram Protocol (UDP), or the like, or a combination thereof. It will be understood by one skilled in the art that a communication link may use any suitable type(s) of data transmission protocol(s), now known or later developed. In some examples, one or more communication links may comprise at least one wired link, such as a wire, a cable, an optical fiber, or the like, or a combination thereof. In examples described herein, one or more communication links may comprise at least one wireless link, such as a Wi-Fi-based link, a cellular-based link, or the like, or a combination thereof. In examples described herein, one or more communication links may comprise at least one wireless link based on (e.g., in response to) at least one RF communication technology, such as ZigBee®, Z-Wave®, Bluetooth®, Bluetooth® Low Energy, or the like, or a combination thereof. In examples described herein, one or more communication links may comprise a combination of at least one wired link and at least one wireless link. It will be understood by one skilled in the art that one or more communication links may use any suitable type(s) of wired and/or wireless link(s), now known or later developed.

In examples described herein, a MEC orchestrator may be a computing device comprising a plurality of storage devices and one or more controllers to interact with clients and sites.

In examples described herein, a “computing device” may be a server, storage device, storage array, desktop or laptop computer, switch, router, gateway, controller, access point, or any other processing device or equipment including a processing resource. In examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. In examples described herein, a processing resource may fetch, decode, and execute instructions stored on a storage medium to perform the functionalities described in relation to the instructions stored on the storage medium. In other examples, the functionalities described in relation to any instructions described herein may be implemented in the form of electronic circuitry, in the form of executable instructions encoded on a machine-readable storage medium, or a combination thereof. The storage medium may be located either in the computing device executing the machine-readable instructions, or remote from but accessible to the computing device (e.g., via a computer network) for execution. In the example of FIG. 1, storage medium 120 may be implemented by one machine-readable storage medium, or multiple machine-readable storage media.

In examples described herein, the term “Wi-Fi” is meant to encompass any type of wireless communications that conforms to any IEEE 802.11 standards, whether 802.11ac, 802.11ad, 802.11ay, 802.11ax, 802.11a, 802.11n, 802.11g, etc. The term “Wi-Fi” is currently promulgated by the Wi-Fi Alliance®. Any products tested and approved as “Wi-Fi Certified” (a registered trademark) by the Wi-Fi Alliance® are certified as interoperable with each other, even if they are from different manufacturers. A user with a “Wi-Fi Certified” (a registered trademark) product can use any brand of network hardware with any other brand of network hardware that also is certified. Typically, however, any Wi-Fi product using the same radio frequency band (e.g., 5 GHz band for 802.11ac) will work with any other, even if such products are not “Wi-Fi Certified.” The term “Wi-Fi” is further intended to encompass future versions and/or variations on the foregoing communication standards. Each of the foregoing standards is hereby incorporated by reference.

As used herein, the term “Bluetooth” is meant to encompass any type of wireless communications that conforms to at least one of the Bluetooth® specifications. As used therein, the term “Bluetooth Low Energy” is meant to encompass any type of wireless communications that conforms to at least one of the Bluetooth® Low Energy specifications. The terms “Bluetooth” and “Bluetooth Low Energy” are currently promulgated by the Bluetooth SIG.

As used herein, the term “ZigBee” is meant to encompass any type of wireless communication that conforms to at least one of the specifications of the ZigBee® Specification. The term “ZigBee” is currently promulgated by the ZigBee Alliance. As used herein, the term “Z-Wave” is meant to encompass any type of wireless communication that conforms to at least one of the Z-Wave® protocols. The term “Z-Wave” is currently promulgated by Zensys Corporation.

As used herein, “latency” is a time interval between the transmission and response (e.g., reception) of a signal across a communication link. Latency may depend on the material(s) and/or medium being used for establishing the communication link. Latency may be measured by a one-way delay time between transmitted and received signals (e.g., packets), a round-trip delay time between transmitted and received signals, or a combination thereof.

As used herein, “throughput” refers to a rate of successful data transmission across a communication link (e.g., a wired or wireless link). Throughput may depend on a bandwidth of the communication link, a maximum rate of data transmission (i.e., peak data rate or peak bit rate) across the communication link, or a combination thereof. Moreover, throughput may depend on an amount of data packet loss during data transmission across the communication link. For example, a network device may increase throughput, and thereby improve performance, by increasing bandwidth of a communication link, reducing data packet loss during data transmission across the communication link, or a combination thereof. The throughput of a wireless link may be diminished by degradation of signal quality of wireless signals transmitted and/or received to establish the wireless link.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard disk drive (HDD)), a solid state drive, any type of storage disc (e.g., a compact disc, a DVD, etc.), or the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components. In some examples, instructions may be part of an installation package that, when installed, may be executed by a processing resource to implement functionalities described herein.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

While the present techniques may be susceptible to various modifications and alternative forms, the examples discussed above have been shown only by way of example. It is to be understood that the techniques are not intended to be limited to the particular examples disclosed herein. Indeed, the present techniques include all alternatives, modifications, and equivalents falling within the true spirit and scope of the appended claims.

In other examples, the functionalities described above in relation to instructions described herein may be implemented by one or more engines which may be any combination of hardware and programming to implement the functionalities of the engine(s). In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one of the engine(s). In some examples, the at least one machine-readable storage medium may store instructions that, when executed by the at least one processing resource, at least partially implement some or all of the engine(s). In such examples, a computing device may include the at least one machine-readable storage medium storing the instructions and the at least one processing resource to execute the instructions. In other examples, the engine may be implemented by electronic circuitry.

All of the features disclosed in this specification (including any accompanying claims, abstract and drawings), and/or all of the elements of any method or process so disclosed, may be combined in any combination, except combinations where at least some of such features and/or elements are mutually exclusive.

What is claimed is:

1. A multi-access edge computing (MEC) orchestrator, comprising:
at least one processing resource; and
at least one non-transitory machine-readable storage medium comprising instructions executable by at least one processing resource to:
receive a request to deploy an application according a plurality of requirements of a service level agreement (SLA);
in response to the request, identify a plurality of components of the application and a plurality of sites of a distributed computing environment;
determine a plurality of mappings of the components to the plurality of sites, wherein for each mapping, each component is mapped to a single site capable of satisfying at least one of the requirements;
assign, for each mapping, a tier among a plurality of tiers of the SLA that corresponds to a most stringent requirement among the requirements that must be satisfied by the sites according to that mapping; and
select, among the mappings, a first mapping that is assigned to the tier among the assigned tiers having a highest availability for the most stringent requirement; and
deploy at least one of the components to the sites according to the first mapping.

2. The MEC orchestrator of claim 1, wherein each site comprises compute and storage resources which are connected to a unique Layer 2 (L2) network.

3. The MEC orchestrator of claim 1, wherein each site is located at a unique location at an edge of the distributed computing environment.

4. The MEC orchestrator of claim 1, wherein the requirements comprise compute and storage requirements, and for each mapping, compute and storage requirements of each component are capable of being satisfied by compute and storage resources at a single mapped site.

5. The MEC orchestrator of claim 4, wherein the instructions to deploy at least one of the components to the sites according to the first mapping comprise instructions executable by the at least one processing resource to:
deploy, at each site, any components mapped to that site in an order based on a policy of the SLA, either until (i) all components mapped to that site have been deployed, or (ii) there are not enough available compute and storage resources at that site to deploy any additional components mapped to that site.

6. The MEC orchestrator of claim 5, wherein the instructions comprise instructions executable by the at least one processing resource to:
determine whether all of the components have been deployed to the sites according to first mapping; and
based on a determination that all of the components have not been deployed to the sites according to the first mapping:
undeploy all of the deployed components;
select a second mapping which is assigned to the tier among the assigned tiers having the second highest availability for the most stringent requirement; and
deploy at least one of the components to the sites according to the second mapping.

7. The MEC orchestrator of claim 1, wherein the requirements comprise link latency requirements, and for each mapping, each link latency requirement between the components is capable of being satisfied by a communication link between the sites.

8. The MEC orchestrator of claim 1, wherein the instructions to deploy at least one of the components to the sites according to the first mapping comprise instructions executable by the at least one processing resource to:
determine, between the components, at least one tree mapping of a plurality of link throughput requirements according to the SLA; and
for each tree mapping, establish communication links between the sites to satisfy the link throughput requirements between the components in an order based on a policy of the SLA, either until (i) all communication links are established to satisfy the link throughput requirements between the components, or (ii) there is not enough available link throughput capacity between the sites to establish any additional communication links between the components.

9. The MEC orchestrator of claim 8, wherein the at least one tree mapping of link throughput requirements between the components is determined by packing Steiner trees to the first mapping.

10. The MEC orchestrator of claim 9, wherein the instructions comprise instructions executable by the at least one processing resource to:
determine whether all communication links have been established to satisfy the link throughput requirements between the components according to the first mapping; and
based on a determination that all communication links have not been established to satisfy the link throughput requirements between the components according to the first mapping:
select a second mapping which is assigned to the tier among the assigned tiers having the second highest availability for the most stringent requirement; and
deploy at least one of the components to the sites according to the second mapping.

11. The MEC orchestrator of claim 1, wherein the requirements comprise compute and storage requirements and link latency requirements, and for each mapping, compute and storage requirements of each component are capable of being satisfied by compute and storage resources at a single mapped site and each link latency requirement between the components is capable of being satisfied by a communication link between the sites.

12. The MEC orchestrator of claim 1, wherein each tier comprises a latency requirement, a throughput requirement, a compute and storage requirement, an availability requirement, or a combination thereof.

13. A method for deploying an application in a distributed computing environment, comprising:
identifying, by a processing resource, a plurality of components of the application, a plurality of requirements of the application according to a service level agreement (SLA), and a plurality of sites of the distributed computing environment;
determining, by the processing resource, a plurality of mappings of the components to the plurality of sites, wherein for each mapping, each component is mapped to a single site capable of satisfying at least one of the requirements;
assigning, by the processing resource for each mapping, a tier among a plurality of tiers of the SLA that corresponds to a most stringent requirement among the requirements that must be satisfied by the sites according to that mapping; and
selecting, by the processing resource among the mappings, a first mapping that is assigned the tier among the assigned tiers having a highest availability for the most stringent requirement; and
deploying at least one of the components to the sites according to the first mapping.

14. The method of claim 13, wherein the requirements comprise compute and storage requirements, and for each mapping, compute and storage requirements of each component are capable of being satisfied by compute and storage resources at a single mapped site.

15. The method of claim 14, wherein deploying at least one of the components to the sites according to the first mapping comprises:
deploying, by the processing resource at each site, any components mapped to that site in an order based on a policy of the SLA, either until (i) all components mapped to that site have been deployed, or (ii) there are not enough available compute and storage resources at that site to deploy any additional components mapped to that site.

16. The method of claim 15, further comprising:
determining, by the processing resource, whether all of the components have been deployed to the sites according to first mapping; and
based on a determination that all of the components have not been deployed to the sites according to the first mapping:
undeploying all of the deployed components;
selecting, by the processing resource, a second mapping which is assigned to the tier among the assigned tiers having a next highest availability for the most stringent requirement; and
deploying at least one of the components to the sites according to the second mapping.

17. The method of claim 13, wherein the requirements comprise link latency requirements, and for each mapping, each link latency requirement between the components is capable of being satisfied by a communication link between the sites.

18. The method of claim 17, wherein deploying one or more of the components to the sites according to the first mapping comprises:
determining, by the processing resource between the components, at least one tree mapping of link throughput requirements, wherein the link throughput requirements are according to the SLA;
for each tree mapping, establish communication links between the sites to satisfy the link throughput requirements between the components in an order based on a policy of the SLA, either until (i) all communication links are established to satisfy the link throughput requirements between the components, or (ii) there is not enough available link throughput capacity between the sites to establish any additional communication links between the components.

19. The method of claim 18, further comprising:
determining, by the processing resource, whether all communication links have been established to satisfy the link throughput requirements between the components according to the first mapping; and
based on a determination that all communication links have not been established to satisfy the link throughput requirements between the components according to the first mapping:
selecting, by the processing resource, a second mapping which is assigned to the tier among the assigned tiers having a next highest availability for the most stringent requirement; and
deploying at least one of the components to the sites according to the second mapping.

20. An article comprising at least one non-transitory machine-readable storage medium comprising instructions executable by at least one processing resource of a first storage array to:
identify a plurality of components of an application, a plurality of requirements of the application according to a service level agreement (SLA), and a plurality of sites of a distributed computing environment;
determine a plurality of mappings of the components to the sites, wherein for each mapping, the sites are capable of satisfying at least one of the requirements;
assign, for each mapping, a tier among a plurality of tiers of the SLA that corresponds to a most stringent requirement among the requirements that must be satisfied by the sites according to that mapping; and
select, among the mappings, a first mapping that is assigned to the tier among the assigned tiers having a highest availability for the most stringent requirement; and
deploy at least one of the components to the sites according to the first mapping.
